(19) United States
(12) Patent Application Publication
(10) Pub. No.: US 2024/0330664 A1
(43) Pub. Date: Oct. 3, 2024

(54) APPARATUS AND METHOD FOR GENERATING SIGNED BIT SLICE, SIGNED BIT SLICE CALCULATOR, AND ARTIFICIAL INTELLIGENCE NEURAL NETWORK ACCELERATOR TO WHICH THE SAME IS APPLIED

(71) Applicant: Korea Advanced Institute of Science and Technology, Daejeon (KR)

(72) Inventors: Hoi Jun YOO, Daejeon (KR); Dong Seok IM, Daejeon (KR)

(73) Assignee: Korea Advanced Institute of Science and Technology, Daejeon (KR)

(21) Appl. No.: 18/381,218

(22) Filed: Oct. 18, 2023

(30) Foreign Application Priority Data
Mar. 31, 2023 (KR) 10-2023-0043166

(51) Int. Cl. G06N 3/063

(52) U.S. Cl. CPC G06N 3/063

(57) ABSTRACT

A signed bit slice generator includes a divider configured to divide input data, which is 2's complement data having N (where N is a natural number)-bit precision, and divide remaining bits excluding a sign bit of the input data into a predetermined number of bit slices, a sign bit adder configured to add a sign bit to each of the bit slices, a sign value setter configured to set a sign bit of an MSB slice among the bit slices to a sign value of the input data and to set sign bits of the remaining bit slices to positive sign values, and a sparse data compressor configured to perform sparse data compression on each of the signed bit slices, thereby generating a predetermined number of signed bit slices having the same number of bits where each bit slice includes a sign bit.

### BACKGROUND OF THE INVENTION

### Field of the Invention

The present invention relates to technology for accelerating an artificial intelligence (AI) neural network, and more particularly to an apparatus and method for generating signed bit slices, a signed bit slice calculator for calculating the signed bit slices generated using the method, and an AI neural network accelerator to which the same is applied.

### Description of the Related Art

In order to increase acceleration efficiency of an AI neural network accelerator, a bit slice hardware architecture that divides data of a predetermined bit length into a plurality of bit slices and performs calculation thereon has been used (J.-W. Jang, et al., “Sparsity-Aware and Re-configurable NPU Architecture for Samsung Flagship Mobile SoC,” ISCA, pp. 15-28, 2021. and C.-H. Lin, et al., “3.4-to-13.3 TOPS/W 3.6 TOPS Dual-Core Deep-Learning Accelerator for Versatile AI Applications in 7 nm 5G Smartphone SoC,” ISSCC, pp. 134-136, 2020.), technologies for improving computational performance of such a bit slice hardware architecture have been additionally proposed.

For example, D. Han, et al., “HNPU: An Adaptive DNN Training Processor Utilizing Stochastic Dynamic Fixed-Point and Active Bit-Precision Searching,” IEEE JSSC, 2018. discloses a hardware architecture that skips a calculation process between bit slices having a value of 0 in a process of dividing data of a predetermined bit length into bit slices, and M. Song, et al., “Prediction Based Execution on Deep Neural Networks,” ISCA, pp. 752-763, 2018. discloses a hardware architecture that predicts a size of an output value by first calculating an upper bit slice, and then skips remaining lower bit slice calculation.

However, the conventional hardware architectures described above have the following limitations.

First, when the hardware architecture disclosed in D. Han, et al., “HNPU: An Adaptive DNN Training Processor Utilizing Stochastic Dynamic Fixed-Point and Active Bit-Precision Searching,” IEEE JSSC, 2018. is applied to 2's complement data, there is a limitation in improving hardware performance since bit slices having a value 0 are limited to positive data. A reason therefor is that, when a bit slice is created from 2's complement data, an upper bit slice value of positive data near 0 has a value 0, whereas an upper bit slice value of negative data near a value 0 has a value −1. Meanwhile, when examining a data distribution of AI neural network inputs and weights, data is concentrated around a value 0, and among the data, a distribution of negative data near the value 0 occupies 50% or more. Therefore, the technology of D. Han, et al., “HNPU: An Adaptive DNN Training Processor Utilizing Stochastic Dynamic Fixed-Point and Active Bit-Precision Searching,” IEEE JSSC, 2018. has limitations in improving hardware performance since the technology cannot utilize sparsity of negative data near the value 0, which occupies such a large amount.

In addition, when the hardware architecture disclosed in M. Song, et al., “Prediction Based Execution on Deep Neural Networks,” ISCA, pp. 752-763, 2018. is applied to 2's complement data, there is a problem of causing a lot of speculation errors in an output speculation method of predicting an output value by first calculating an upper bit slice. A reason therefor is that, since negative data is more than positive data by one piece in 2's complement representation, even when the signs are different and size values are the same in data of all bits, there is a difference in size value of an upper bit slice. As an example, upper 4-bit slices of −25 (=1100_111(2)) and 25 (=0011_001(2)) are −4 (=1100(2)) and 3 (=0011 (2)), which are different values, and this problem causes a large output value speculation error of 19.9% in max pooling maximum value speculation of the VoteNet AI neural network.

Finally, a conventional bit slice hardware architecture generally occupies a large logic area. A reason therefor is that, even though data skipping is performed only once in the case of a hardware architecture that supports skipping of all bit 0-value data, as much data skipping as the number of bit slices is required in the case of a hardware architecture that supports 0-value bit slice skipping, which additionally requires as much skipping logic as the number of bit slices.

In addition, in the conventional method, since a lower bit slice does not have a sign, unlike an upper bit slice including a sign, code extension logic is additionally required to have a sign, and a calculator having an extended bit length due to sign extension is required.

Due to this additional logic, the conventional bit slice hardware architecture occupies a large logic area. For example, a 4-bit slice architecture occupies 2.07 times the area of a full 8-bit architecture for the same yield.

As such, conventionally, in a bit slice calculation method, which is represented as a method of accelerating bit precision of various AI neural networks, there is a big problem in a bit slice representation method and a bit slice calculation hardware architecture, and thus improvement is required.

### SUMMARY OF THE INVENTION

Therefore, the present invention provides an apparatus and method in which, when 2's complement data having N (where N is a natural number)-bit precision is divided into M (where M is a natural number and M<N) bit slices, signed bit slices having the same length where each bit slice has a sign bit are generated, so that sign extension is not required when multiplying and accumulating bit slices (MAC), and as a result, a calculator having an extended bit length is not used, so that the area of arithmetic logic may be reduced.

In addition, the present invention provides an apparatus and method for repeating a process of adding a sign bit value of full-length data to a least significant bit (LSB) of each signed bit slice and then subtracting the value from a sign bit of an immediately lower adjacent signed bit slice, thereby increasing the number of bits each having a value 0 in each of the signed bit slices, so that it is possible to increase a data compression rate during sparse data compression, improve a calculation speed during sparse data skipping calculation, and reduce power consumption at the same time.

In addition, the present invention provides an apparatus and method for calculating the signed bit slices to utilize sparsity of both positive data near the value 0 and negative data near the value 0 in 2's complement data, so that it is possible to increase a data compression rate during sparse data compression, improve a calculation speed during sparse data skipping calculation, and reduce power consumption at the same time.

In addition, the present invention provides a signed bit slice calculator for making the number of positive bit slices and the number of negative bit slices the same so that values of the signed bit slices are symmetrical, thereby reducing output value speculation errors through an upper bit slice calculation, so that accuracy of an AI neural network due to speculation calculation may be improved, and an AI neural network accelerator to which the same is applied.

In addition, the present invention provides an AI neural network accelerator for performing an upper bit slice calculation through sparse input skipping calculation, speculating a size of a final output value based on a resultant value, and then making input values corresponding to sparse output positions speculated during lower bit slice calculation sparse, thereby simultaneously performing skipping calculations of sparse input bit slice and sparse output data calculations, so that a calculation speed may be improved.

In addition, the present invention provides an AI neural network accelerator capable of unifying sparse input bit slice compression and sparse output data compression methods since input values corresponding to sparse output positions are made sparse and calculated, so that a calculation speed may be improved.

In addition, the present invention provides an AI neural network accelerator configured to fetch the same number of input data and weight data to perform multiplication and accumulation calculations so that skipping conversion is easy between the input data and the weight data, and thus skip more sparse data among the input data and the weight data to accelerate AI neural network calculation so that a calculation speed of the AI neural network may be improved.

In accordance with an aspect of the present invention, the above and other objects can be accomplished by the provision of an AI neural network accelerator including a data management unit (DMU core) configured to generate a predetermined number of signed bit slices from input data, which is 2's complement data having N (where N is a natural number)-bit precision, and then compress and manage the signed bit slices, a skipping calculation unit (zero-slice-skip PE) configured to perform multiplication and addition calculates of the signed bit slices and data skipping calculation in units of bit slices, and an accumulation unit configured to accumulate and store a calculation result of the skipping calculation unit (zero-slice-skip PE) by an external control instruction.

The DMU core may include a signed bit slice generation unit (SBR unit) configured to generate the signed bit slices, and a signed bit slice compression unit (RLE unit) configured to compress the signed bit slices, and the SBR unit may include a divider configured to divide input data, which is 2's complement data having N (where N is a natural number)-bit precision, and divide remaining bits excluding a sign bit of the input data into a predetermined number of bit slices, a sign bit adder configured to add a sign bit to each of the bit slices, and a sign value setter configured to set a sign bit of a most significant bit (MSB) slice among the bit slices to a sign value of the input data and to set sign bits of the remaining bit slices to positive sign values.

The skipping calculation unit (zero-slice-skip PE) may include an input buffer IBUF configured to receive and store an input bit slice, which is a compressed signed bit slice, from the DMU core, an index buffer IDXBUF configured to store a compression index, which is a storage position of the input bit slice, a weight buffer WBUF configured to store weight data implemented as the signed bit slices, a skipping unit (zero-skip unit) configured to calculate an address of the weight buffer WBUF from which weight data is to be fetched based on the compression index, and a calculator array including a plurality of signed bit slice calculators and configured to read an input bit slice from the input buffer IBUF, and read weight data from the weight buffer WBUF using address information calculated by the skipping unit (zero-skip unit) to perform multiplication and accumulation calculations.

The signed bit slice calculator may include a multiplication calculator configured to sequentially perform multiplication calculation on the input bit slice and the weight data, an addition calculator configured to accumulate a calculation result of the multiplication calculator, and a register configured to store a calculation result of the addition calculator.

The AI neural network accelerator may further include a weight skipping calculation controller configured to compare sparsity between the input data and the weight data, and control operations of the DMU core, the skipping calculation unit (zero-slice-skip PE), and the accumulation unit so that, when the sparsity of the weight data is higher than the sparsity of the input data, weight skipping calculation is performed.

A method of generating a bit slice includes dividing, by a bit slice generator, input data, which is 2's complement data having N (where N is a natural number) −bit precision, and dividing remaining bits excluding a sign bit of the input data into a predetermined number of bit slices, adding, by the bit slice generator, a sign bit to each of the bit slices, setting, by the bit slice generator, a sign bit of an MSB slice among the bit slices to a sign value of the input data, and setting sign bits of the remaining bit slices to positive sign values, and performing, by the bit slice generator, sparse data compression on each of the signed bit slices.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic block diagram of an AI neural network accelerator according to an embodiment of the present invention;

FIG. 2 is a schematic block diagram of a signed bit slice generation/compression unit according to an embodiment of the present invention;

FIG. 3 is a diagram for elaborating an operation of a sign bit calculator according to an embodiment of the present invention;

FIG. 4 is a process flowchart for a method of generating signed bit slices according to an embodiment of the present invention;

FIG. 5 is a diagram for describing a process of generating signed bit slices according to an embodiment of the present invention as an example;

FIG. 6 illustrates a process of performing sparse input skipping calculation and sparse output skipping calculation using an output binary mask according to an embodiment of the present invention;

FIG. 7 is a diagram for comparing and describing a signed bit slice calculator according to an embodiment of the present invention with a conventional bit slice calculator; and

FIG. 8 is a diagram for describing a weight skipping calculation process according to an embodiment of the present invention.

### DETAILED DESCRIPTION OF THE INVENTION

Hereinafter, embodiments of the present invention will be described with reference to the accompanying drawings, and will be described in detail so that those skilled in the art may easily practice the present invention. However, the present invention may be embodied in many different forms and is not limited to the embodiments described herein. Meanwhile, in order to clearly describe the present invention in the drawings, parts irrelevant to the description are omitted, and similar reference numerals are attached to similar parts throughout the specification. In addition, descriptions of parts that may be easily understood by those skilled in the art even when detailed descriptions are omitted.

Throughout the specification and claims, when a part is described as including a certain component, this description means that the part may further include other components, not excluding other components, unless stated otherwise.

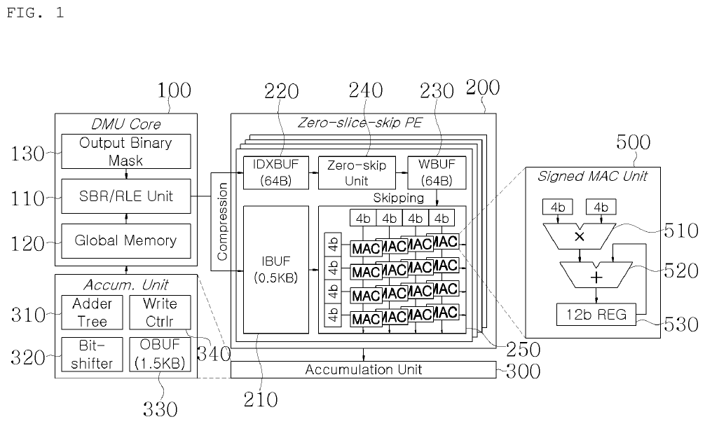

FIG. 1 is a schematic block diagram of an AI neural network accelerator according to an embodiment of the present invention. Referring to FIG. 1, the AI neural network accelerator according to the embodiment of the present invention includes a data management unit (DMU core) 100, a skipping calculation unit (zero-slice-skip PE) 200, and an accumulation unit 300.

The DMU core 100 generates a predetermined number of signed bit slices from input data, which is 2's complement data having N (where N is a natural number)-bit precision, and then compresses and manages the signed bit slices. To this end, the DMU core 100 may include a signed bit slice generation/compression unit (SBR/RLE unit) 110, a memory (global memory) 120, and an output binary mask unit 130.

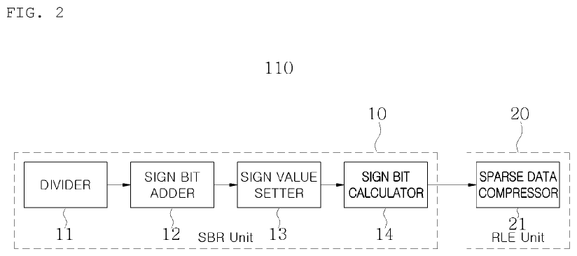

At this time, the signed bit slices refer to bit slices each including a sign bit and having the same number of bits, and the SBR/RLE unit 110 generates and then compresses the signed bit slices. A configuration of the SBR/RLE unit 110 is illustrated in FIG. 2.

FIG. 2 is a schematic block diagram of a signed bit slice generation/compression unit according to an embodiment of the present invention. Referring to FIG. 2, the SBR/RLE unit 110 includes a signed bit slice generation unit (SBR unit) 10 configured to generate signed bit slices, and a signed bit slice compression unit (RLE unit) 20, in which the SBR unit 10 may include a divider 11, a sign bit adder 12, a sign value setter 13, and a sign bit calculator 14, and the RLE unit 20 may include a sparse data compressor 21.

The divider 11 divides input data, which is 2's complement data having N (where N is a natural number)-bit precision, and divides the remaining bits excluding a sign bit of the input data into a predetermined number of bit slices. For example, in the case of 2's complement data having 7-bit precision, the divider 11 may divide 6 bits excluding the MSB bit representing the sign into two 3-bit slices or three 2-bit slices.

The sign bit adder 12 adds a sign bit to each of the bit slices divided by the divider 11. In the case of an MSB slice among the divided bit slices, since the sign bit of the input data is present, the sign bit adder 12 adds a sign bit to each of all the remaining bit slices except for the MSB slice. In the above example, when 7-bit input data is divided into two 3-bit slices, since the sign bit of the input data is present in the upper 3-bit bit slice, the sign bit adder 12 adds a sign bit only to the lower 3-bit bit slice. In this case, two 4-bit bit slices will be created. Meanwhile, when 7-bit input data is divided into two 3-bit slices, the sign bit adder 12 adds a sign bit to each of the remaining two 2-bit slices excluding the uppermost 2-bit bit slice. In this case, three 3-bit bit slices will be created.

The sign value setter 13 sets a sign value of each of the sign bits added by the sign bit adder 12. At this time, since the code value of the input data is previously stored in the sign bit of the MSB slice among the predetermined number of bit slices, the sign value setter 13 sets a code value of each of the sign bits of the remaining bit slices. However, since all of the remaining bit slices except for the MSB slice represent positive numbers, the sign value setter 13 may set the sign value of each of the sign bits of the remaining bit slices to a positive sign value.

The sign bit calculator 14 repeats a calculation process of adding a sign bit value of full-length data to the LSB of each signed bit slice and subtracting the value from a sign bit of an immediately lower adjacent signed bit slice. This process is performed to increase the number of bits each having a value 0 in each of the signed bit slices, and the sign bit calculator 14 may repeat the above calculation process as many times as the number of bit slices. As a result, it is possible to obtain an effect of increasing a sparse data compression ratio when performing calculation using such bit slices or when accelerating the AI neural network.

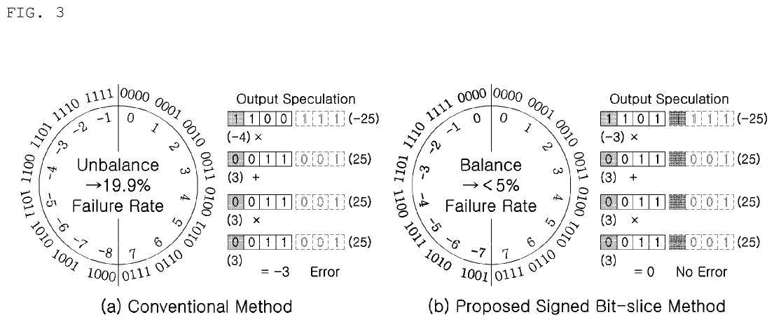

Meanwhile, to reduce an output error rate when an output speculation method is used, the sign bit calculator 14 may make the number of positive bit slices and the number of negative bit slices the same, so that bit slice values are symmetrical. To this end, the sign bit calculator 14 may skip the above calculation process when the signed bit slice value is a preset specific value. That is, the sign bit calculator 14 may exceptionally add a sign and skip the above calculation process (that is, the calculation process of adding a sign bit value of full-length data to the LSB of each signed bit slice and subtracting the value from a sign bit of an immediately lower adjacent signed bit slice) when the signed bit slice value is “1000.” Such a process of adding only a sign and skipping the above calculation process will be referred to as an exception process below. For example, when 7-bit data “1100_000” is expressed as a signed bit slice, the data needs to be expressed as “1101” and “1000.” However, the sign bit calculator 14 expresses the data as “1100” and “0000” by performing the exception process on “1100_000,” that is, by adding only a sign and not performing the calculation process. In this way, a value of the bit slice generated through the sign bit calculator 14 is symmetrical as illustrated in FIG. 3B. This is intended to reduce an output speculation error rate when using an output speculation method. When the output speculation method is not used, the above calculation process may be performed on all numbers without the exception process.

At this time, the “output speculation method” is known technology commonly performed to improve efficiency of an AI neural network accelerator in an AI neural network capable of speculating an output as a situation where the output value is 0. Therefore, a description of a specific processing process thereof is omitted.

FIG. 3 is a diagram for elaborating an operation of the sign bit calculator according to an embodiment of the present invention, and illustrates error rates for the case (FIG. 3B) where the number of positive bit slices and the number of negative bit slices are made the same by skipping the above calculation process and the case (FIG. 3A) where the numbers are not made the same. FIG. 3A illustrates that, when “1000” is not skipped, that is, when the exception process is not performed, the left and right sides of the 2's complement wheel are not symmetrical, and as a result, an output speculation error rate is 19.9%, and FIG. 3B illustrates that, when “1000” is skipped, that is, when the exception process is performed, the left and right sides of the 2's complement wheel are symmetrical, and as a result, an output speculation error rate is less than 5%.

The sparse data compressor 21 performs sparse data compression on each of the signed bit slices generated by the SBR unit 10. To this end, the sparse data compressor 21 may apply a run-length encoding method.

Meanwhile, the sparse data compressor 21 generates non-zero data and an index indicating a position of this data as a result of compressing the sparse data, and then stores the non-zero data in an input buffer (IBUF) 210 to be described later and stores the index in an index buffer (IDXBUF) 220 to be described later, respectively.

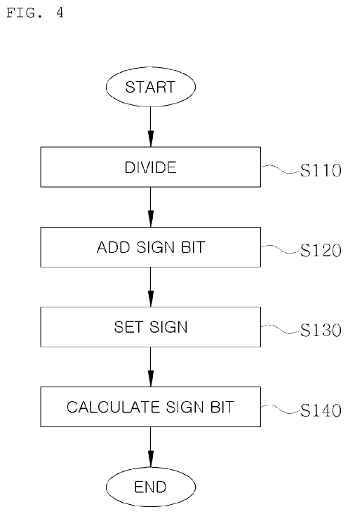

In this way, a processing process for generating signed bit slices by the SBR/RLE unit 110 is illustrated in FIG. 4.

FIG. 4 is a process flowchart for a method of generating signed bit slices according to an embodiment of the present invention, and the method of generating signed bit slices according to the embodiment of the present invention will be described with reference to FIGS. 2 and 4 as follows.

First, in step S110, the divider 11 divides input data, which is 2's complement data having N (where N is a natural number)-bit precision, and divides remaining bits excluding a sign bit of the input data into a predetermined number of bit slices.

In step S120, the sign bit adder 12 adds a sign bit to each of the bit slices.

In step S130, the sign value setter 13 sets a sign bit of an MSB slice among the bit slices to a sign value of the input data, and sets sign bits of the remaining bit slices to positive sign values.

In step S140, the sign bit calculator 14 repeats a calculation process of adding a sign bit value of full-length data to the LSB of each signed bit slice and subtracting the value from a sign bit of an immediately lower adjacent signed bit slice. This process is performed to increase the number of bits each having a value 0 in each of the signed bit slices.

Meanwhile, in step S140, the sign bit calculator 14 may skip the calculation process when the signed bit slice value is a preset specific value (that is, “1000”) in order to reduce the output speculation error rate when using the output speculation method by making the number of positive bit slices and the number of negative bit slices the same.

Each of the signed bit slices generated through this process may be applied to the AI neural network accelerator through sparse data compression (not illustrated) in the sparse data compressor 21.

In the description of FIG. 4, redundant descriptions of content mentioned in the description of the apparatus of FIG. 2 are omitted.

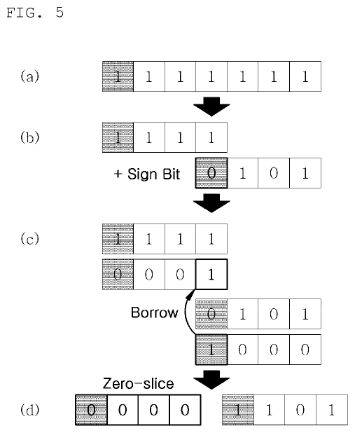

FIG. 5 is a diagram for describing a process of generating signed bit slices according to an embodiment of the present invention as an example, and describes a process of dividing input data, which is 7-bit 2's complement data (A) (1111101), into signed bit slices according to an embodiment of the present invention as an example.

FIG. 5A illustrates a state before the input data is divided into bit slices (that is, raw data). At this time, an MSB is a sign bit indicating the sign of the input data. Such input data is expressed as a mathematical expression illustrated in Equation 1.

$$A = - {a}_{6} \cdot {2}^{6} + {\sum }_{i = 0}^{5} {a}_{i} \cdot {2}^{i} \qquad [ Equation 1 ]$$

FIG. 5B illustrates a state in which the input data is divided into two bit slices, then a sign bit is added, and a positive sign value 0 is set to the sign bit. Usually, when specific data is divided into bit slices, while an upper bit slice includes a sign bit of the input data, a lower bit slice does not include a sign bit, so that lengths of the bit slices are different from each other. In the present invention, as illustrated in FIG. 5B, by performing a process of adding a sign bit to a bit slice on a lowermost side, and then setting a positive code value to the added sign bit, the lengths of the bit slices may be made the same.

In this way, in the process of dividing the input data into two bit slices as illustrated in Equation 1, an example in which the sign bit −0×2³ is added to the lower bit slice is expressed a mathematical expression illustrated in Equation 2.

$$\begin{matrix}A = ( - {a}_{6} \cdot {2}^{6} + {a}_{5} \cdot {2}^{5} + {a}_{4} \cdot {2}^{4} + {a}_{3} \cdot {2}^{3} ) \\ + ( - 0 \cdot {2}^{3} + {a}_{2} \cdot {2}^{2} + {a}_{1} \cdot {2}^{1} + {a}_{0} \cdot {2}^{0} )\end{matrix} \qquad [ Equation 2 ]$$

FIG. 5C illustrates a result of performing a process of adding an MSB bit (that is, sign bit) value a₀ of the input data to the upper bit slice and subtracting the value from the lower bit slice in order to increase the number of bit slices having values 0 in each of the bit slices, the lengths of which are the same due to addition of the sign bit. Equation 3 illustrates this calculation process.

$$\begin{matrix}A = ( - {a}_{6} \cdot {2}^{6} + {a}_{5} \cdot {2}^{5} + {a}_{4} \cdot {2}^{4} + {a}_{3} \cdot {2}^{3} ) + {a}_{6} \cdot {2}^{3} \\ + ( - 0 \cdot {2}^{3} + {a}_{2} \cdot {2}^{2} + {a}_{1} \cdot {2}^{1} + {a}_{0} \cdot {2}^{0} ) \\ + ( - {a}_{6} \cdot {2}^{3} )\end{matrix} \qquad [ Equation 3 ]$$

FIG. 5D illustrates two bit slices generated through the above process. Referring to FIG. 5D, the two bit slices each have a 4-bit length and a sign. In particular, in the case of the upper bit slice, 1111(2) is converted into 0000(2) through the process illustrated in FIG. 5C to become a zero-value bit slice (namely, zero-slice).

In this way, due to the characteristics of the signed bit slices in which a value 1111, which is the upper bits, is converted to a value 0000, the present invention may utilize sparseness of negative data near 0 in which the upper bits have the value 1111. As a result, in 2′ complement data, sparsity of both positive data near 0 and negative data near 0 may be utilized.

This is expressed as an equation as illustrated in Equation 4.

$$A = {A}_{3}^{′} \cdot {2}^{3} + {A}_{0}^{′} \qquad [ Equation 4 ]$$

This signed bit slice representation method may be applied to various bit length precisions and various bit slice lengths.

First, any 2's complement N-bit data may be expressed as illustrated in Equation 5.

$$A = - {a}_{N - 1} {2}^{N - 1} + {\sum }_{i = 0}^{N - 2} {a}_{i} {2}^{j} \qquad [ Equation 5 ]$$

At this time, a₁ has a value 0 or 1, and a_{N-1} denotes a sign bit.

Meanwhile, when an M-bit (where M is 2, 3, 4, . . . ) slice is taken for any N-bit (where N is M, M+(M−1), M+2*(M−1), . . . ) data A, an expression thereof may be obtained as illustrated in Equation 6.

$$A = - {a}_{N - 1} {2}^{N - 1} + {\sum }_{i = 0}^{\frac{N - 1}{M - 1} - 1} ( {\sum }_{j = ( M - 1 )}^{( M - 1 ) ( M - 2 )} \text{?} {a}_{j} {2}^{j} ) \qquad [ Equation 6 ]$$

$$\text{?} \text{indicates text missing or illegible when filed}$$

In order to create signed M-bit slices from the data A expressed as illustrated in Equation 6, (M−1) bits may be grouped and sorted as (N−1)/(M−1) groups illustrated in Equation 7.

$$\begin{matrix}A = - {a}_{N - 1} {2}^{N - 1} \\ + ( {a}_{N - 2} {2}^{N - 2} + ⋯ + {a}_{N - 1 - ( M - 1 ) + 1} {2}^{N - 1 - ( M - 1 ) + 1} + \\ {a}_{N - 1 - ( M - 1 )} {2}^{N - 1 - ( M - 1 )} ) \\ + ⋯ \\ + ( {a}_{2 M - 3} {2}^{2 M - 3} + ⋯ + {a}_{M - 2} {2}^{M - 2} + {a}_{M - 1} {2}^{M - 1} ) \\ + ( {a}_{M - 2} {2}^{M - 2} + ⋯ + {a}_{1} {2}^{1} + {a}_{0} {2}^{0} )\end{matrix} \qquad [ Equation 7 ]$$

Meanwhile, when the sign bit a_{N-1} is added to or subtracted from each bit slice group in the data A expressed as in Equation 7, the data A may be arranged as illustrated in Equation 8.

$$\begin{matrix}A = - a \text{?} 2 \text{?} + a \text{?} 2 \text{?} \\ + ( a \text{?} 2 \text{?} + a \text{?} 2 \text{?} + ⋯ + a \text{?} 2 \text{?} + a \text{?} 2 \text{?} + a \text{?} 2 \text{?} ) \\ + ⋯ \\ + ( - a \text{?} 2 \text{?} + a \text{?} 2 \text{?} + ⋯ + a \text{?} 2 \text{?} + a \text{?} 2 \text{?} + a \text{?} 2 \text{?} ) \\ + ( - a \text{?} 2 \text{?} + a \text{?} 2 \text{?} + ⋯a \text{?} 2 \text{?} + a \text{?} 2 \text{?} )\end{matrix} \qquad [ Equation 8 ]$$

$$\text{?} \text{indicates text missing or illegible when filed}$$

In this way, the sign bit is added to each bit slice group, and when Equation 8 is rearranged using an M-bit sign bit slice A′, Equation 9 is obtained.

$$A = ( {A}_{N - 1 - ( M - 1 )}^{′} \times {2}^{N - 1 - ( M - 1 )} ) + ⋯ + ( {A}_{M - 1}^{′} \times {2}^{M - 1} ) + {A}_{0}^{′} \qquad [ Equation 9 ]$$

When Equation 9 is used, the signed bit slice representation method of the present invention may be applied to any 2's complement data. As a specific example, when 2's complement data A is divided into 4-bit (M=4) slices, the 2's complement data A may be arranged by grouping three bit values, and Equation 6 may be expressed as the following Equation 10.

$$\begin{matrix}A = - {a}_{N - 1} {2}^{N - 1} \\ + ( {a}_{N - 2} {2}^{N - 2} + {a}_{N - 3} {2}^{N - 3} + {a}_{N - 4} {2}^{N - 4} ) \\ + ( {a}_{N - 5} {2}^{N - 5} + {a}_{N - 6} {2}^{N - 6} + {a}_{N - 7} {2}^{N - 7} ) \\ + ⋯ \\ + ( {a}_{2} {2}^{2} + {a}_{1} {2}^{1} + {a}_{0} {2}^{0} )\end{matrix} \qquad [ Equation 10 ]$$

At this time, N indicates 4, 7, 10, 13, . . . .

Meanwhile, when the sign bit a_{N-1} is added to or subtracted from each bit slice group in Equation 10, the data A may be rearranged as the following Equation 11.

$$\begin{matrix}A = - {a}_{N - 1} {2}^{N - 1} + {a}_{N - 1} {2}^{N - 1} \\ + ( - {a}_{N - 1} {2}^{N - 1} + {a}_{N - 2} {2}^{N - 2} + ⋯ + {a}_{N - 4} {2}^{N - 4} + {a}_{N - 1} {2}^{N - 4} ) \\ + ( - {a}_{N - 1} {2}^{N - 4} + {a}_{N - 5} {2}^{N - 5} + ⋯ + {a}_{N - 7} {2}^{N - 7} + {a}_{N - 1} {2}^{N - 7} ) \\ + ⋯ \\ + ( - {a}_{N - 1} {2}^{3} + {a}_{2} {2}^{2} + {a}_{1} {2}^{1} + {a}_{0} {2}^{0} )\end{matrix} \qquad [ Equation 11 ]$$

As a result, a sign bit is added to each bit slice group, and when Equation 11 is rearranged using a 4-bit sign bit slice A′, Equation 12 is obtained.

$$A = ( {A}_{N - 4}^{′} \times {2}^{N - 4} ) + ( {A}_{N - 7}^{′} \times {2}^{N - 7} ) + ⋯ + {A}_{0}^{′} \qquad [ Equation 12 ]$$

In this way, the SBR/RLE unit 110 may divide and express any 2's complement data using the signed bit slice representation method, and the bit slice calculator and the AI neural network accelerator of the present invention may reduce the area of calculation logic using such signed bit slices. As a result, it is possible to reduce a size of hardware and to improve a calculation speed and reduce power consumption at the same time.

Referring back to FIG. 1, the memory (global memory) 120 stores raw data (that is, data before being divided into bit slices) for accelerating the AI neural network, and delivers the raw data to the SBR/RLE unit 110, so that signed bit slices may be generated.

The output binary mask unit 130 generates a binary mask by receiving input of a skipping calculation result for an upper bit slice from the skipping calculation unit (zero-slice-skip PE) 200 to be described later. To this end, the output binary mask unit 130 performs comparison calculation between resultant values of the skipping calculation to generate a binary mask corresponding to max-pooling output in which a value corresponding to a maximum value is expressed as 1 and a value other than the value (value 0) is expressed as 0. In addition, the output binary mask unit 130 delivers the output binary mask to the SBR/RLE unit 110 so that the output speculation method may be used when the output speculation method is applied to the AI neural network accelerator.

The SBR/RLE unit 110 (in particular, a sparse data compressor 20) newly compresses sparse input data using the output binary mask.

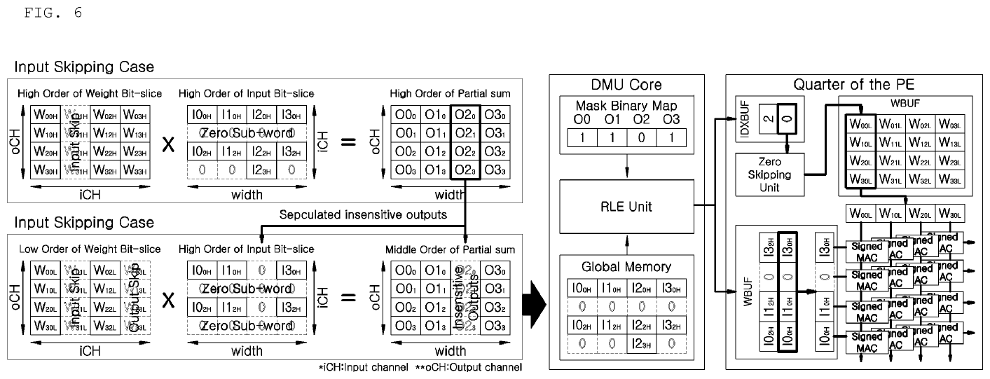

FIG. 6 illustrates a process of performing sparse input skipping calculation and sparse output skipping calculation using an output binary mask according to an embodiment of the present invention. Referring to FIG. 6, the output binary mask unit 130 generates a 4-bit binary mask (1101) by receiving input of a sparse input skipping calculation result for an upper bit slice from the skipping calculation unit (zero-slice-skip PE) 200, the SBR/RLE unit 110 (in particular, the sparse data compressor 20) newly compresses the sparse input data using the output binary mask (1101), and the skipping calculation unit (zero-slice-skip PE) 200 receives the newly compressed sparse input data and performs skipping calculation.

The skipping calculation unit (zero-slice-skip PE) 200 performs multiplication and addition calculations of the signed bit slices and data skipping calculation in units of bit slices.

To this end, the skipping calculation unit (zero-slice-skip PE) 200 includes an input buffer IBUF 210, an index buffer IDXBUF 220, a weight buffer WBUF 230, a skipping unit (zero-skip unit) 240, and a calculator array 250.

The input buffer IBUF 210 receives and stores input bit slices, which are compressed signed bit slices, from the DMU core 100.

The index buffer IDXBUF 220 stores a compression index, which is a storage position of each of the input bit slices.

The weight buffer WBUF 230 stores weight data implemented as the signed bit slices.

The skipping unit (zero-skip unit) 240 calculates an address of a weight buffer WBUF from which weight data is to be fetched based on the compression index.

The calculator array 250 includes a plurality of signed bit slice calculators 500, reads input bit slices from the input buffer IBUF 210, and performs multiplication and accumulation calculation by reading weight data from the weight buffer WBUF 230 based on address information calculated by the skipping unit (zero-skip unit) 240.

The signed bit slice calculator 500 includes a multiplication calculator 510 configured to sequentially performs multiplication calculation on the input bit slice and the weight data, an addition calculator 520 configured to accumulate calculation results of the multiplication calculator 510, and a register 530 configured to store calculation results of the addition calculator 520. The signed bit slice calculator 500 calculates signed bit slices generated by the SBR/RLE unit 110, and each of the signed bit slices is data of the same length including a sign bit. Therefore, the signed bit slice calculator 500 of the present invention does not additionally require separate logic for extending the sign, and may be implemented using bit length-optimized logic.

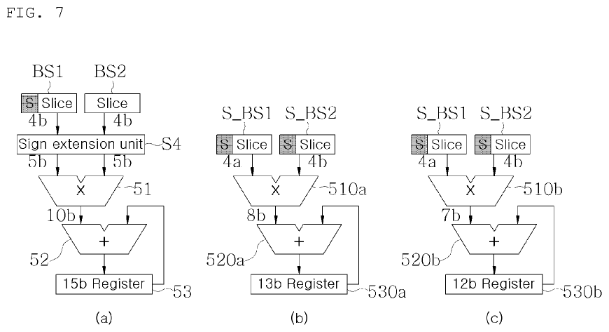

FIG. 7 is a diagram for comparing and describing the signed bit slice calculator according to an embodiment of the present invention with a conventional bit slice calculator, in which FIG. 7A illustrates an example of a structure of the conventional bit slice calculator, and FIGS. 7B and 7C illustrate examples of structures of signed bit slice calculators according to first and second embodiments of the present invention.

Referring to FIG. 7A, conventionally, in order to calculate an upper bit slice BS1 having a sign and a lower bit slice BS2 having no sign, sign extension logic 54 is additionally required so that the lower bit slice BS2 has a sign. Therefore, the 4-bit upper bit slice BS1 and the lower bit slice BS2 are each extended to 5-bit data through the sign extension logic 54 and output, and each of a multiplication calculator 51, an addition calculator 52, and a register 53 needs to be configured to have a size suitable for such extended data. That is, in the above example, the addition calculator 52 receives a 10-bit calculation result from the multiplication calculator 51, then performs calculation, and stores an accumulated calculation result in the register 53, and the register 53 is implemented as a 15-bit register.

Meanwhile, referring to FIGS. 7B and 7C, the signed bit slice calculator of the present invention does not require sign extension logic since both an upper signed bit slice S_BS1 and a lower signed bit slice S_BS2 have sign bits, and thus uses multiplication calculators 510a and 510b, addition calculators 520a and 520b, and registers 530a and 530b having optimized bit lengths.

That is, the multiplication calculator 510a illustrated in FIG. 7A directly performs multiplication calculation on the 4-bit signed bit slices S_BS1 and S_BS2 without sign extension, and then outputs an 8-bit calculation result, and the addition calculator 520a accumulates the 8-bit calculation result and stores the 8-bit calculation result in the 13-bit register 530a.

Meanwhile, the multiplication calculator 510b illustrated in FIG. 7C directly performs multiplication calculation on the 4-bit signed bit slices S_BS1 and S_BS2 without sign extension, and then outputs a 7-bit calculation result, and the addition calculator 520b accumulates the 7-bit calculation result and stores the 7-bit calculation result in the 12-bit register 530b since the number of positive bit slices and the number of negative bit slices are made the same when the signed bit slices are generated in order to reduce output speculation errors at the time of using the output speculation method. That is, when the number of positive bit slices and the number of negative bit slices are made the same, as illustrated in FIG. 3, there is no case where the value of the signed bit slice is “1000,” and thus all data may be expressed using 7 bits.

Meanwhile, the skipping calculation unit (zero-slice-skip PE) 200 performs data skipping calculation in units of bit slices using the signed bit slices, and performs skipping calculation when all of several consecutive pieces of bit slice data have values 0. In this case, since a known technology may be used for a processing procedure for the data skipping calculation, a detailed description thereof will be omitted.

The accumulation unit 300 accumulates and stores calculation results of the skipping calculation unit (zero-slice-skip PE) 200. To this end, the accumulation unit 300 includes an adder tree 310 for accumulation calculation, a bit-shifter 320 configured to perform bit-shift to determine calculation positions of the bit slices, an output buffer OBUF 330 configured to buffer output data, and a write controller Write Ctrlr 340, and may be operated by an external control instruction. For example, the accumulation unit 300 may accumulate and store the calculation results according to a control instruction delivered from a top controller (not illustrated).

Meanwhile, the AI neural network accelerator of the present invention may compare sparsity between input data and weight data and operate to perform weight skipping calculation when the sparsity of the weight data is higher than that of the input data. To this end, the AI neural network accelerator of the present invention may further include a weight skipping calculation controller (not illustrated) configured to control the weight skipping calculation.

The weight skipping calculation controller may compare sparsity between the input data and the weight data, and control operations of the DMU core, the skipping calculation unit (zero-slice-skip PE), and the accumulation unit so that, when the sparsity of the weight data is higher than that of the input data, the weight skipping calculation is performed.

That is, when the sparsity of the weight data is higher than that of the input data, the weight skipping calculation controller may control an operation of the DMU core so that the weight data is compressed and a weight bit slice, which is a compressed signed bit slice, is output, may control an operation of the skipping calculation unit (zero-slice-skip PE) so that the weight bit slice is stored in the input buffer IBUF, a compression index, which is a storage position of the weight bit slice, is stored in the index buffer, and input data implemented as the signed bit slice is stored in the weight buffer WBUF, and may control an operation of the accumulation unit so that output data of the skipping calculation unit (zero-slice-skip PE) is rearranged and stored in the output buffer OBUF.

At this time, the weight skipping calculation controller compares sparsity between “input data implemented as a signed bit slice (before compression)” and “weight data implemented as a signed bit slice (before compression).” That is, the weight skipping calculation controller may determine a sparse calculation target by comparing the sparsity when compressing the input data and the weight data after expressing the input data and the weight data as signed bit slices. In particular, the weight skipping calculation controller determines a sparse calculation target of the corresponding layer by comparing part of data rather than comparing sparsity between all input data and all weight data for each layer of a deep neural network. Both the input data and the weight data are stored in the memory (global memory) 120 of the DMU core 100, and positions thereof are known to the top controller (that is, a central processing unit).

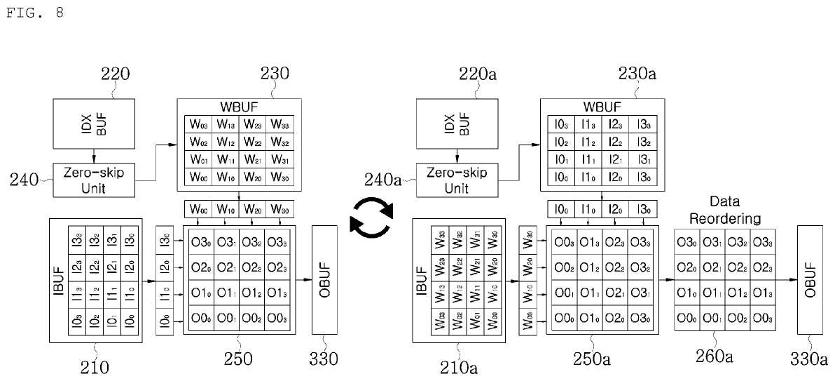

FIG. 8 is a diagram for describing a weight skipping calculation process according to an embodiment of the present invention, in which FIG. 8A illustrates general data skipping calculation (that is, skipping calculation of input data), and FIG. 8B illustrates a weight skipping calculation process.

Referring to FIG. 8A, for skipping calculation of input data, the skipping calculation unit (zero-slice-skip PE) 200 stores input data I in the input buffer IBUF 210, stores a compression index in an index buffer 220, and stores weight data W into a weight buffer 230, respectively, and then the calculator array 250 performs calculation thereof. Then, results thereof are stored in the output buffer 330.

Referring to FIG. 8B, for skipping calculation of weight data, the skipping calculation unit (zero-slice-skip PE) 200 stores the weight data W in an input buffer IBUF 210a, stores a compression index of the weight data W in an index buffer 220a, and stores input data I in a weight buffer 230a, respectively, and then a calculator array 250a performs calculation thereof. Meanwhile, the write controller Write Ctrlr 340 of the accumulation unit 300 rearranges (260a) a calculation result thereof and then stores the calculation result in the output buffer 330.

For this reason, the present invention may improve the AI neural network calculation speed more efficiently by skipping more sparse data among the input data and the weight data to accelerate the AI neural network calculation.

As described above, the present invention is characterized in that, when 2's complement data having N (where N is a natural number)-bit precision is divided into M (where M is a natural number and M<N) bit slices, signed bit slices having the same length where each bit slice has a sign bit are generated, so that sign extension is not required when multiplying and accumulating bit slices (MAC), and as a result, a calculator having an extended bit length is not used, so that the area of arithmetic logic may be reduced.

In addition, the present invention is characterized in that, by repeating a process of adding a sign bit value of full-length data to an LSB of each signed bit slice and then subtracting the value from a sign bit of an immediately lower adjacent signed bit slice, the number of bits each having a value 0 is increased in each of the signed bit slices, so that it is possible to increase a data compression rate during sparse data compression, improve a calculation speed during sparse data skipping calculation, and reduce power consumption at the same time.

In addition, the present invention is characterized in that the signed bit slices may be calculated to utilize sparsity of both positive data near the value 0 and negative data near the value 0 in 2's complement data, so that it is possible to increase a data compression rate during sparse data compression, improve a calculation speed during sparse data skipping calculation, and reduce power consumption at the same time.

In addition, the present invention is characterized in that the number of positive bit slices and the number of negative bit slices are made the same so that values of the signed bit slices are symmetrical, thereby reducing output value speculation errors through an upper bit slice calculation, so that accuracy of an AI neural network due to speculation calculation may be improved.

In addition, the present invention is characterized in that an upper bit slice calculation is performed through sparse input skipping calculation, a size of a final output value is speculated based on a resultant value, and then input values corresponding to sparse output positions speculated during lower bit slice calculation are made sparse, thereby simultaneously performing skipping calculations of sparse input bit slice and sparse output data calculations, so that a calculation speed may be improved.

In addition, the present invention is characterized in that it is possible to unify sparse input bit slice compression and sparse output data compression methods since input values corresponding to sparse output positions are made sparse and calculated, so that a calculation speed may be improved.

In addition, the present invention is characterized in that the same number of input data and weight data are fetched to perform multiplication and accumulation calculations so that skipping conversion is easy between the input data and the weight data, and thus more sparse data among the input data and the weight data is skipped to accelerate AI neural network calculation so that a calculation speed of the AI neural network may be improved.

As described above, the present invention has an advantage in that, when 2's complement data having N (where N is a natural number)-bit precision is divided into M (where M is a natural number and M<N) bit slices, signed bit slices having the same length where each bit slice has a sign bit are generated, so that sign extension is not required when multiplying and accumulating bit slices (MAC), and as a result, an calculator having an extended bit length is not used, so that the area of arithmetic logic may be reduced.

In addition, the present invention has an advantage of repeating a process of adding a sign bit value of full-length data to the LSB of each signed bit slice and then subtracting the value from a sign bit of an immediately lower adjacent signed bit slice, thereby increasing the number of bits each having a value 0 in each of the signed bit slices, so that it is possible to increase a data compression rate during sparse data compression, improve a calculation speed during sparse data skipping calculation, and reduce power consumption at the same time.

In addition, the present invention has an advantage of calculating the signed bit slices to utilize sparsity of both positive data near the value 0 and negative data near the value 0 in 2's complement data, so that it is possible to increase a data compression rate during sparse data compression, improve a calculation speed during sparse data skipping calculation, and reduce power consumption at the same time.

In addition, the present invention has an advantage of making the number of positive bit slices and the number of negative bit slices the same so that values of the signed bit slices are symmetrical, thereby reducing output value speculation errors through upper bit slice calculation, so that accuracy of an AI neural network due to speculation calculation may be improved.

In addition, the present invention has an advantage of performing an upper bit slice calculation through sparse input skipping calculation, speculating a size of a final output value based on a resultant value, and then making input values corresponding to sparse output positions speculated during lower bit slice calculation sparse, thereby simultaneously performing skipping calculations of sparse input bit slice and sparse output data calculations, so that a calculation speed may be improved.

In addition, the present invention has an advantage of being able to unify sparse input bit slice compression and sparse output data compression methods since input values corresponding to sparse output positions are made sparse and calculated, so that a calculation speed may be improved.

In addition, the present invention has an advantage of fetching the same number of input data and weight data to perform multiplication and accumulation calculations so that skipping conversion is easy between the input data and the weight data, and thus skipping more sparse data among the input data and the weight data to accelerate AI neural network calculation so that a calculation speed of the AI neural network may be improved.

In the above description, preferred embodiments of the present invention have been presented and described. However, the present invention is not necessarily limited thereto, and those skilled in the art to which the present invention pertains will readily recognize that various substitutions, modifications, and changes may be made without departing from the technical spirit of the present invention.

What is claimed is:

1. A signed bit slice generator comprising:
a divider configured to divide input data, which is 2's complement data having N (where N is a natural number)-bit precision, and divide remaining bits excluding a sign bit of the input data into a predetermined number of bit slices;
a sign bit adder configured to add a sign bit to each of the bit slices;
a sign value setter configured to set a sign bit of a most significant bit (MSB) slice among the bit slices to a sign value of the input data and to set sign bits of the remaining bit slices to positive sign values; and
a sparse data compressor configured to perform sparse data compression on each of the signed bit slices.

2. The signed bit slice generator according to claim 1, further comprising a sign bit calculator configured to repeat a calculation process of adding a sign bit value of full-length data to a least significant bit (LSB) of each of the signed bit slices and subtracting the value from a sign bit of an immediately lower adjacent signed bit slice to increase the number of bit slices each having a value 0 in each of the signed bit slices.

3. The signed bit slice generator according to claim 2, wherein, when an output speculation method is used, the sign bit calculator skips the calculation process when a signed bit slice value is a preset specific value to make the number of positive bit slices and the number of negative bit slices the same.

4. A method of generating a signed bit slice by a bit slice generator, the method comprising:
dividing, by the bit slice generator, input data, which is 2's complement data having N (where N is a natural number)-bit precision, and dividing remaining bits excluding a sign bit of the input data into a predetermined number of bit slices;
adding, by the bit slice generator, a sign bit to each of the bit slices;
setting, by the bit slice generator, a sign bit of an MSB slice among the bit slices to a sign value of the input data, and setting sign bits of the remaining bit slices to positive sign values; and
performing, by the bit slice generator, sparse data compression on each of the signed bit slices.

5. The method according to claim 4, further comprising repeating a calculation process of adding a sign bit value of full-length data to an LSB of each of the signed bit slices and subtracting the value from a sign bit of an immediately lower adjacent signed bit slice to increase the number of bit slices each having a value 0 in each of the signed bit slices.

6. The method according to claim 5, wherein, when an output speculation method is used, the repeating comprises skipping the calculation process when a signed bit slice value is a preset specific value to make the number of positive bit slices and the number of negative bit slices the same.

7. A bit slice calculator comprising:
a multiplication calculator configured to receive input of a plurality of M-bit signed bit slices having the same length where each bit slice has a sign bit, and to perform multiplication calculation thereof;
an addition calculator configured to accumulate a calculation result of the multiplication calculator; and
a register configured to store a calculation result of the addition calculator.

8. An artificial intelligence (AI) neural network accelerator, comprising:
a data management unit (DMU core) configured to generate a predetermined number of signed bit slices from input data, which is 2's complement data having N (where N is a natural number)-bit precision, and then compress and manage the signed bit slices;
a skipping calculation unit (zero-slice-skip PE) configured to perform multiplication and addition calculates of the signed bit slices and data skipping calculation in units of bit slices; and
an accumulation unit configured to accumulate and store a calculation result of the skipping calculation unit (zero-slice-skip PE) by an external control instruction.

9. The AI neural network accelerator according to claim 8, wherein:
the DMU core comprises:
a signed bit slice generation unit (SBR unit) configured to generate the signed bit slices; and
a signed bit slice compression unit (RLE unit) configured to compress the signed bit slices, and
the SBR unit comprises:
a divider configured to divide input data, which is 2's complement data having N (where N is a natural number) −bit precision, and divide remaining bits excluding a sign bit of the input data into a predetermined number of bit slices;
a sign bit adder configured to add a sign bit to each of the bit slices; and
a sign value setter configured to set a sign bit of an MSB slice among the bit slices to a sign value of the input data and to set sign bits of the remaining bit slices to positive sign values.

10. The AI neural network accelerator according to claim 9, wherein the RLE unit compresses sparse input data for each of the signed bit slices, and generates non-zero data and an index indicating a position of the data.

11. The AI neural network accelerator according to claim 10, wherein the RLE unit compresses the sparse input data using an output binary mask obtained as a result of max-pooling for a skipping calculation result for an MSB slice among skipping calculation results of the skipping calculation unit (zero-slice-skip PE).

12. The AI neural network accelerator according to claim 8, wherein:
the skipping calculation unit (zero-slice-skip PE) comprises:
an input buffer IBUF configured to receive and store an input bit slice, which is a compressed signed bit slice, from the DMU core;
an index buffer IDXBUF configured to store a compression index, which is a storage position of the input bit slice;
a weight buffer WBUF configured to store weight data implemented as the signed bit slices;
a skipping unit (zero-skip unit) configured to calculate an address of the weight buffer WBUF from which weight data is to be fetched based on the compression index; and
a calculator array including a plurality of signed bit slice calculators and configured to read an input bit slice from the input buffer IBUF, and read weight data from the weight buffer WBUF using address information calculated by the skipping unit (zero-skip unit) to perform multiplication and accumulation calculations.

13. The AI neural network accelerator according to claim 12, wherein the signed bit slice calculator comprises:
a multiplication calculator configured to sequentially perform multiplication calculation on the input bit slice and the weight data;
an addition calculator configured to accumulate a calculation result of the multiplication calculator; and
a register configured to store a calculation result of the addition calculator.

14. The AI neural network accelerator according to claim 12, further comprising a weight skipping calculation controller configured to compare sparsity between the input data and the weight data, and control operations of the DMU core, the skipping calculation unit (zero-slice-skip PE), and the accumulation unit so that, when the sparsity of the weight data is higher than the sparsity of the input data, weight skipping calculation is performed,
the weight skipping calculation controller being configured to:
control the DMU core so that the weight data is compressed and a weight bit slice, which is a compressed signed bit slice, is output,
control the skipping calculation unit (zero-slice-skip PE) so that the weight bit slice is stored in an input buffer IBUF, a compression index, which is a storage position of the weight bit slice, is stored in an index buffer, and input data implemented as the signed bit slice is stored in a weight buffer WBUF, and
control an operation of the accumulation unit so that output data of the skipping calculation unit (zero-slice-skip PE) is rearranged and stored in an input buffer (OBUF).
